(19) United States
(12) Patent Application Publication
(10) Pub. No.: US 2026/0276032 A1
(43) Pub. Date: Sep. 17, 2026

(54) HINGE DEVICE

(71) Applicant: FOSITEK CORPORATION, New Taipei City (TW)

(72) Inventors: Yung-Chih TSENG, New Taipei City (TW); Zoen Ryon Ryan Wong, New Taipei City (TW)

(73) Assignee: FOSITEK CORPORATION, New Taipei City (TW)

(21) Appl. No.: 19/233,399

(22) Filed: Jun. 10, 2025

(30) Foreign Application Priority Data
Mar. 14, 2025 (TW) 114109558

(51) Int. Cl. F16C 11/04; G06F 1/16

(52) U.S. Cl. CPC F16C 11/04; G06F 1/1681

(57) ABSTRACT

A hinge device includes a base seat, a rotating unit, and a rotating foot cushion member. The rotating unit includes a rotating member rotating between a first position and a second position, and a connecting protrusion. The rotating foot cushion member rotates between a folded position and a supporting position, and has a cushion groove, a foot cushion body, and a pivot connecting portion. When the rotating member is in the first position, the rotating foot cushion member is in the folded position, and the foot cushion body is relatively close to the base seat. When the rotating member rotates to the second position, the rotating foot cushion member is driven to rotate to the supporting position by the connecting protrusion, and the foot cushion body is relatively far from the base seat.

### CROSS-REFERENCE TO RELATED APPLICATION

This application claims priority to Taiwanese Invention Patent Application No. 114109558, filed on Mar. 14, 2025, the entire disclosure of which is incorporated by reference herein.

### FIELD

The disclosure relates to a hinge, and more particularly to a hinge device that may be used in electronic devices such as a laptop computer.

### BACKGROUND

Typically, when a user use an electronic device such as a laptop computer, he/she often needs to elevate a back side of the laptop computer using a stand to dissipate heat and to increase comfort of using the laptop computer's keyboard. However, the aforementioned stand is not convenient to store or use, and there is still room for improvement of its stability. Therefore, how to conveniently and stably elevate the back side of the laptop computer is a problem to be solved.

### SUMMARY

Therefore, an object of the disclosure is to provide a hinge device that can alleviate at least one of the drawbacks of the prior art.

According to the disclosure, the hinge device includes a base seat, a rotating unit, and a rotating foot cushion member. The rotating unit includes a rotating member and a connecting protrusion. The rotating member is mounted on the base seat and is capable of rotating relative to the base seat about a first rotational axis parallel to a lateral direction between a first position and a second position. The connecting protrusion is driven by the rotating member and is capable of rotating relative to the base seat about a second rotational axis parallel to the lateral direction. The rotating foot cushion member is pivotably mounted on the base seat and is capable of rotating relative to the base seat about a third rotational axis parallel to the lateral direction between a folded position and a supporting position. The rotating foot cushion member has a cushion groove recessed in the lateral direction at one end of the rotating foot cushion member, a foot cushion body at another end of the rotating foot cushion member, and a pivot connecting portion pivotably connected to the base seat between the cushion groove and the foot cushion body. The connecting protrusion of the rotating unit is slidably disposed in the cushion groove. When the rotating member is in the first position, the rotating foot cushion member is in the folded position, and the foot cushion body of the rotating foot cushion member is relatively close to the base seat. When the rotating member rotates to the second position, the rotating foot cushion member is driven to rotate to the supporting position by the connecting protrusion, and the foot cushion body of the rotating foot cushion member is relatively far from the base seat.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic side view of an embodiment of a hinge device according to the present disclosure disposed on an electronic device, illustrating a rotating member of a rotating unit of the embodiment in a first position.

FIG. 2 is a perspective view of the embodiment.

FIG. 3 is a perspective view of the embodiment taken from another angle.

FIG. 4 is an exploded perspective view of FIG. 2.

FIG. 5 is an exploded perspective view of FIG. 3.

FIG. 6 is a schematic side view of the embodiment disposed on the electronic device, illustrating the rotating member of the rotating unit of the embodiment being located between the first position and a transition position.

FIG. 7 is a schematic side view of the embodiment disposed on the electronic device, illustrating the rotating member of the rotating unit of the embodiment in the transition position.

FIG. 8 is a schematic side view of the embodiment disposed on the electronic device, illustrating the rotating member of the rotating unit of the embodiment in a second position.

FIG. 9 is a perspective view of an alternative embodiment of the hinge device according to the present disclosure.

FIG. 10 is a perspective view of the alternative embodiment taken from another angle.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

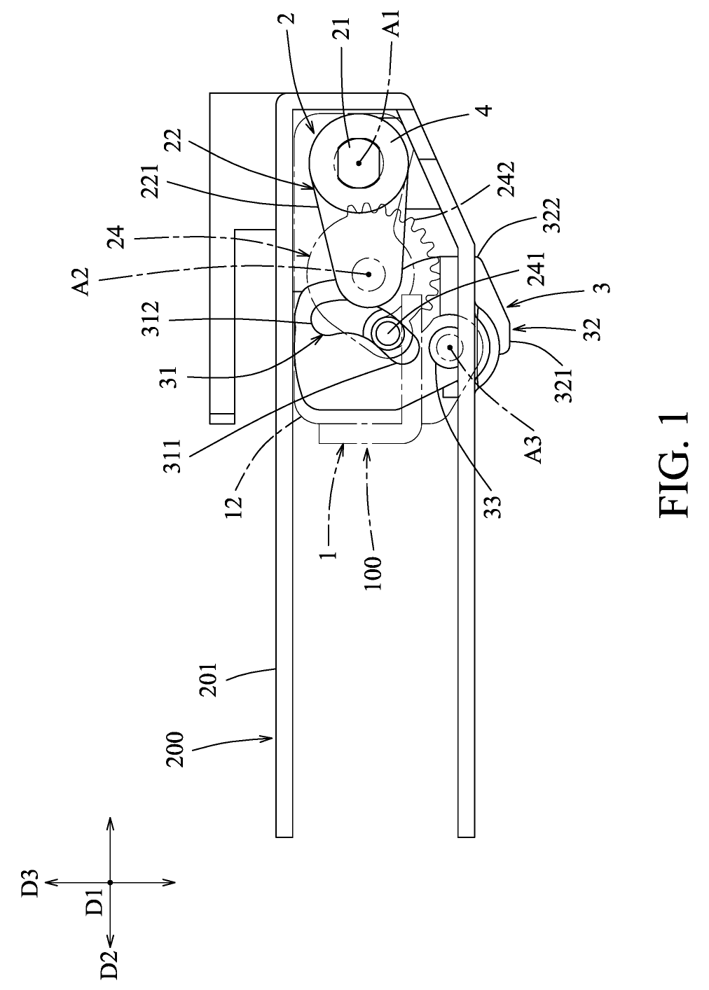

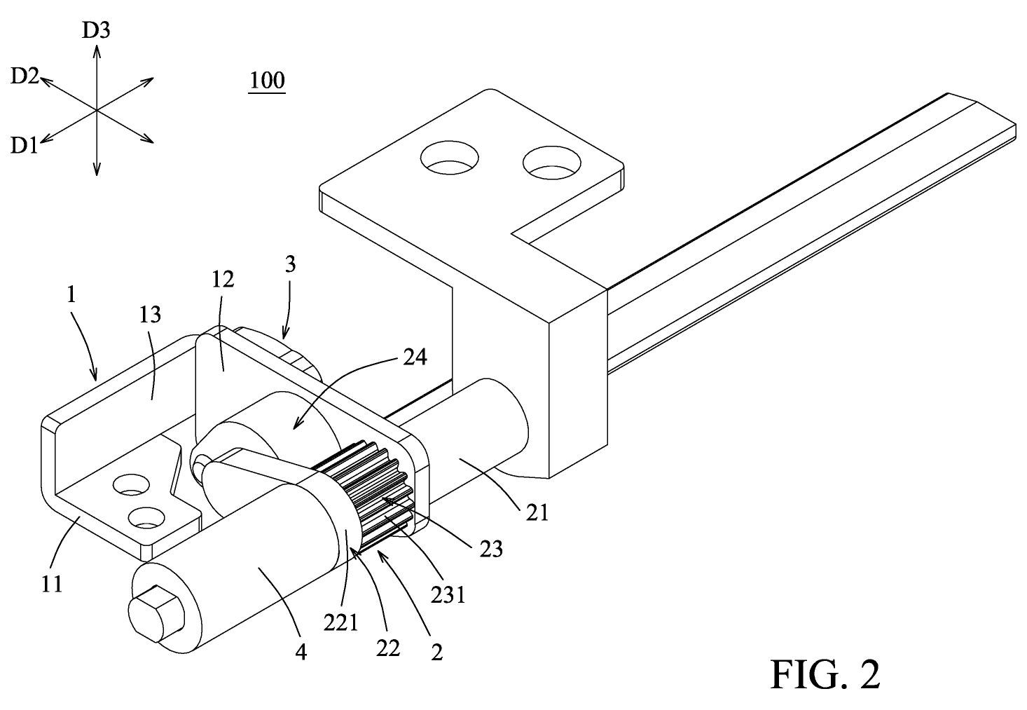

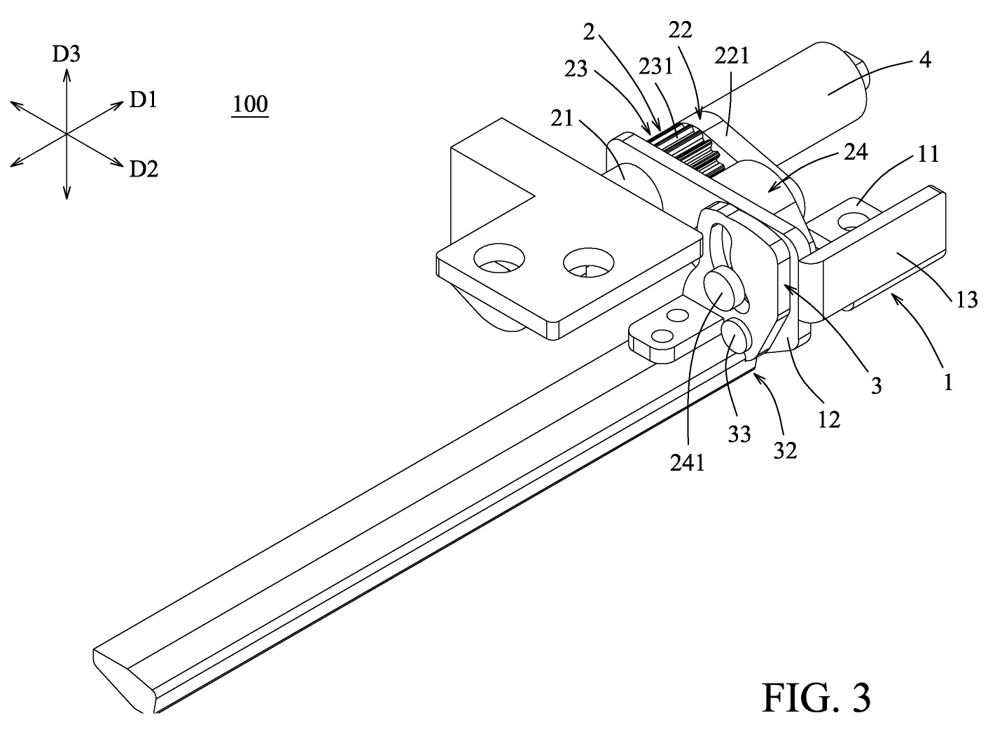

Referring to FIGS. 1-3, an embodiment of the hinge device 100 according to the disclosure is adapted for an electronic device 200. The electronic device 200 may be exemplified as a notebook computer but is not limited thereto. The electronic device 200 includes a first housing 201 and a second housing (not shown). The first housing 201 may include a keyboard, a screen, and a touchpad (not shown). The hinge device 100 is connected between the first housing 201 and the second housing to allow the second housing to open and close relative to the first housing 201.The hinge device 100 includes a base seat 1, a rotating unit 2, and a rotating foot cushion member 3.

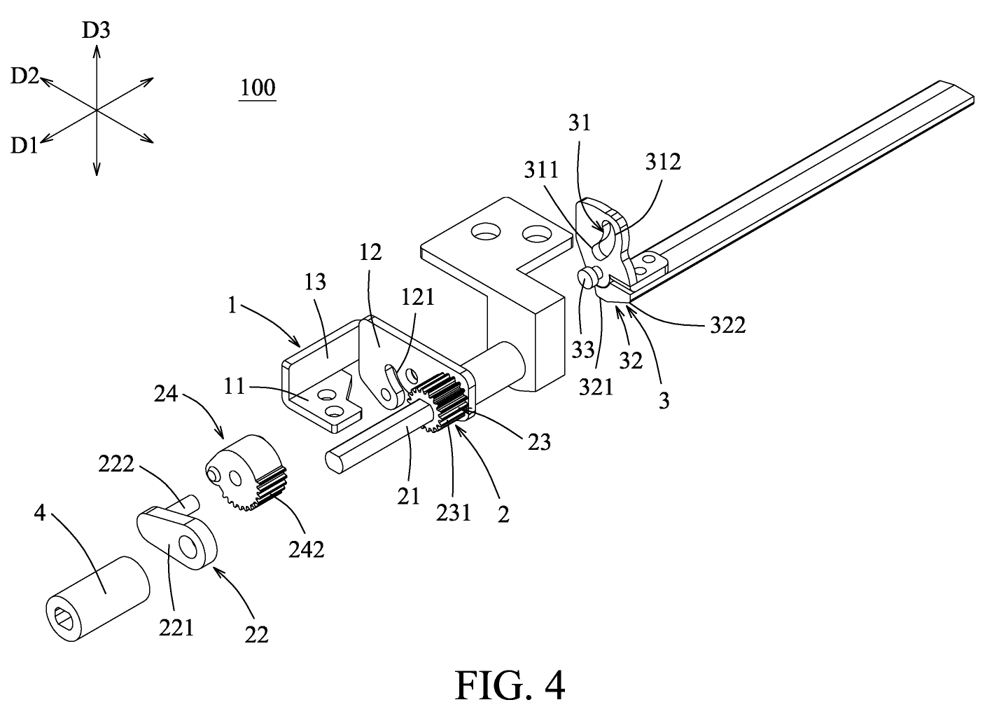

Referring to FIGS. 1-4, the base seat 1 is adapted to be mounted on the first housing 201. In this embodiment, the base seat 1 includes a mounting plate body 11 that extends in a left-right direction (D1, a lateral direction) and a front-rear direction (D2) and that is adapted to be mounted on the first housing 201, an assembly plate body 12 that extend in the front-rear direction (D2) and an up-down direction (D3), and a connecting plate 13 that is connected between the mounting plate body 11 and the assembly plate body 12.

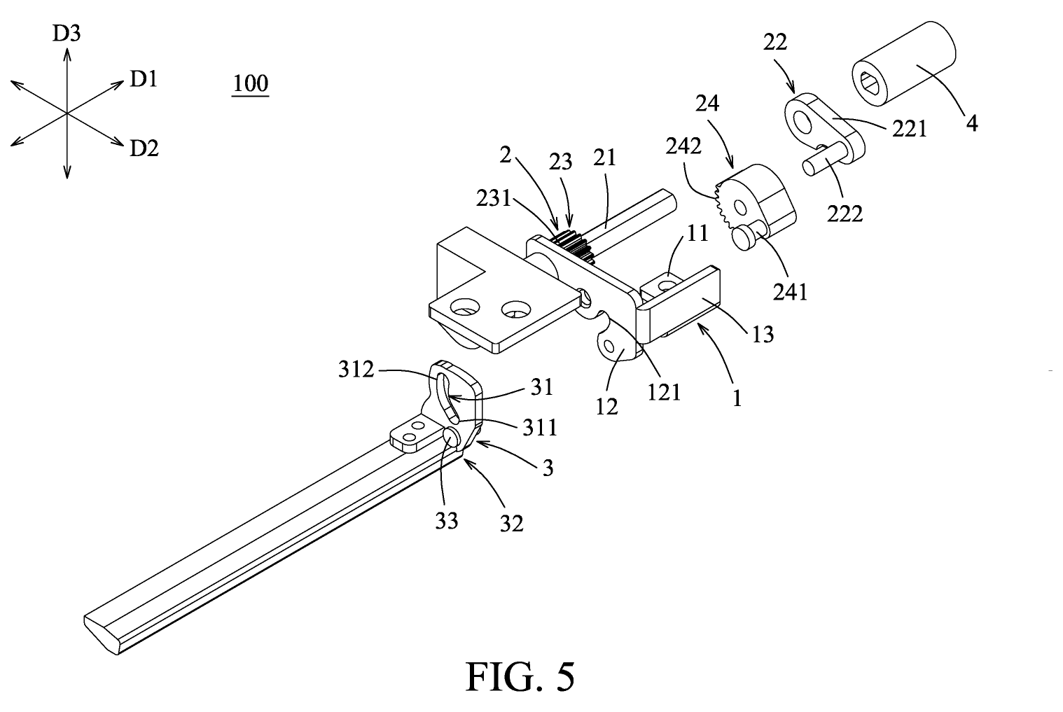

Referring to FIGS. 1-5, the rotating unit 2 includes a rotating member 21, a cam fixing member 22, a driving gear 23, and a cam member 24. The rotating member 21 is mounted on the assembly plate body 12 of the base seat 1 and is capable of rotating relative to the base seat 1 about a first rotational axis (A1) parallel to the left-right direction (D1) between a first position and a second position. The rotating member 21 moves to a transition position during rotation from the first position to the second position relative to the base seat 1. The cam fixing member 22 has a fixing plate body 221 that is fixedly mounted on the rotating member 21 and that does not rotate synchronously with the rotating member 21, and a fixed post 222 that extends in the left-right direction (D1) from the fixing plate body 221 and that is inserted into the assembly plate body 12 of the base seat 1. The driving gear 23 is mounted on the rotating member 21 and synchronously rotates with the rotating member 21. Specifically, the driving gear 23 is located between the assembly plate body 12 of the base seat 1 and the fixing plate body 221 of the cam fixing member 22, and has a driving tooth portion 231.

The cam member 24 is located between the assembly plate body 12 of the base seat 1 and the fixing plate body 221 of the cam fixing member 22. The cam member 24 has a connecting protrusion 241 protruding from one side of the cam member 24, and a cam tooth portion 242 meshing with the driving tooth portion 231 of the driving gear 23. The cam member 24 is mounted on the fixed post 222 and is capable of rotating relative to the base seat 1 about a second rotational axis (A2) parallel to the left-right direction (D1). Through transmission of the driving gear 23, the connecting protrusion 241 (and the cam member 24) is driven by the rotating member 21 to rotate about the second rotational axis (A2), and a rotation direction of the connecting protrusion 241 (the cam member 24) is opposite to that of the rotating member 21. It should be noted that in other embodiments, the connecting protrusion 241 may be directly formed on the rotating member 21, in which case the second rotational axis (A2) coincides with the first rotational axis (A1), and a rotation axis and the rotation direction of the connecting protrusion 241 are same as those of the rotating member 21.

The rotating foot cushion member 3 is pivotably mounted on the base seat 1 and is capable of rotating relative to the base seat 1 about a third rotational axis (A3) parallel to the left-right direction (D1) between a folded position and a supporting position. Specifically, the driving gear 23 and the cam member 24 are located at one side of the assembly plate body 12 of the base seat 1 in the left-right direction (D1), while the rotating foot cushion member 3 is located at another side of the assembly plate body 12 of the base seat 1 in the left-right direction (D1). The rotating foot cushion member 3 includes a cushion groove 31 recessed in the left-right direction (D1) at one end of the rotating foot cushion member 3, a foot cushion body 32 at another end of the rotating foot cushion member 3, and a pivot connecting portion 33 pivotably connected to the base seat 1 and located between the cushion groove 31 and the foot cushion body 32. The cushion groove 31 has a driving portion 311 and an arcuate portion 312 connected to the driving portion 311, and a radius of curvature of the arcuate portion 312 is equal to a distance between the connecting protrusion 241 and the second rotational axis (A2). In this embodiment, the driving portion 311 is straight and tangent to the arcuate portion 312, but in other embodiments, the driving portion 311 may not be straight and may be adjusted according to actual requirements. The connecting protrusion 241 of the rotating unit 2 is slidably disposed in the cushion groove 31. The assembly plate body 12 between the cam member 24 and the rotating foot cushion member 3 has an arc-shaped avoidance groove 121 formed therethrough in the left-right direction (D1) for movement of the connecting protrusion 241. The foot cushion body 32 of the rotating foot cushion member 3 has a first foot cushion portion 321 relatively close to the pivot connecting portion 33 and a second foot cushion portion 322 relatively far from the pivot connecting portion 33.

In addition, in this embodiment, a torque friction member 4 may be disposed on the rotating member 21 to synchronously rotate with the rotating member 21, so as to generate a frictional force with the cam fixing member 22 to resist rotation of the rotating member 21, thereby allowing the electronic device 200 to be positioned at various angles and improving a user's tactile experience when opening and closing the electronic device 200.

Referring to FIG. 1, when the rotating member 21 is in the first position, the second housing is closed relative to the first housing 201. At this time, the connecting protrusion 241 is located at an intersection of the driving portion 311 and the arcuate portion 312 of the cushion groove 31. In this state, the rotating foot cushion member 3 is in the folded position, the foot cushion body 32 of the rotating foot cushion member 3 is relatively close to the base seat 1, and the first foot cushion portion 321 is lower than the second foot cushion portion 322 in position.

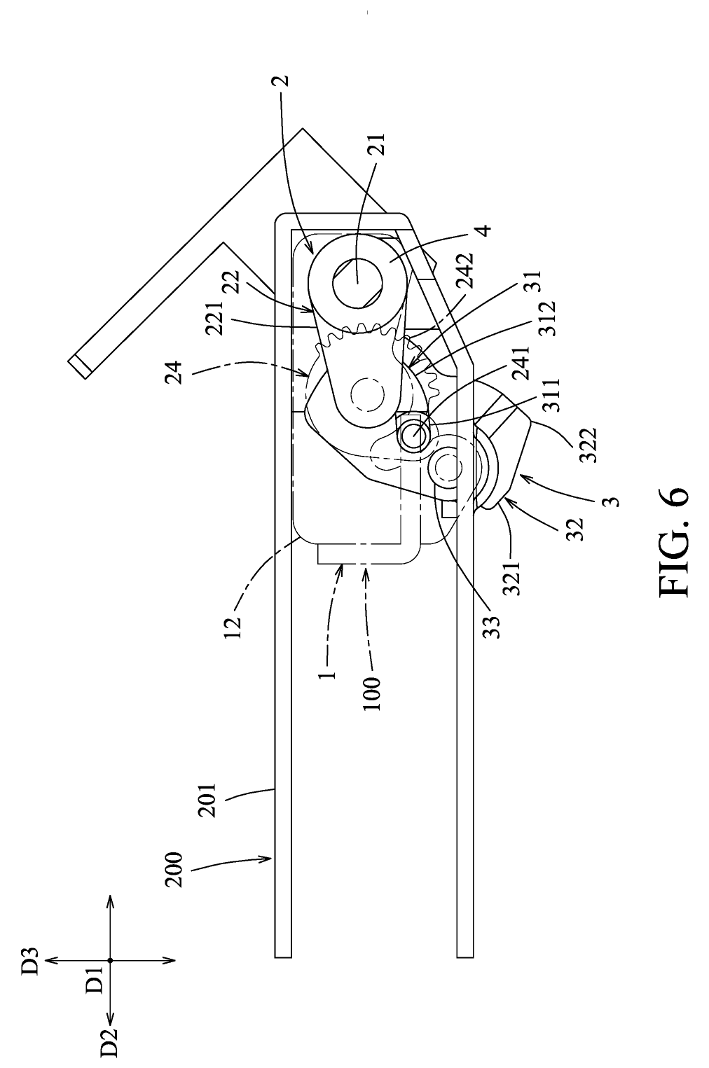

Referring to FIG. 6, when the rotating member 21 rotates from the first position toward the transition position such that the second housing is open relative to the first housing 201 by approximately 45 degrees, the connecting protrusion 241 slides towards a distal end of the driving portion 311 distal from the arcuate portion 312, thereby driving the rotating foot cushion member 3 to rotate toward the supporting position.

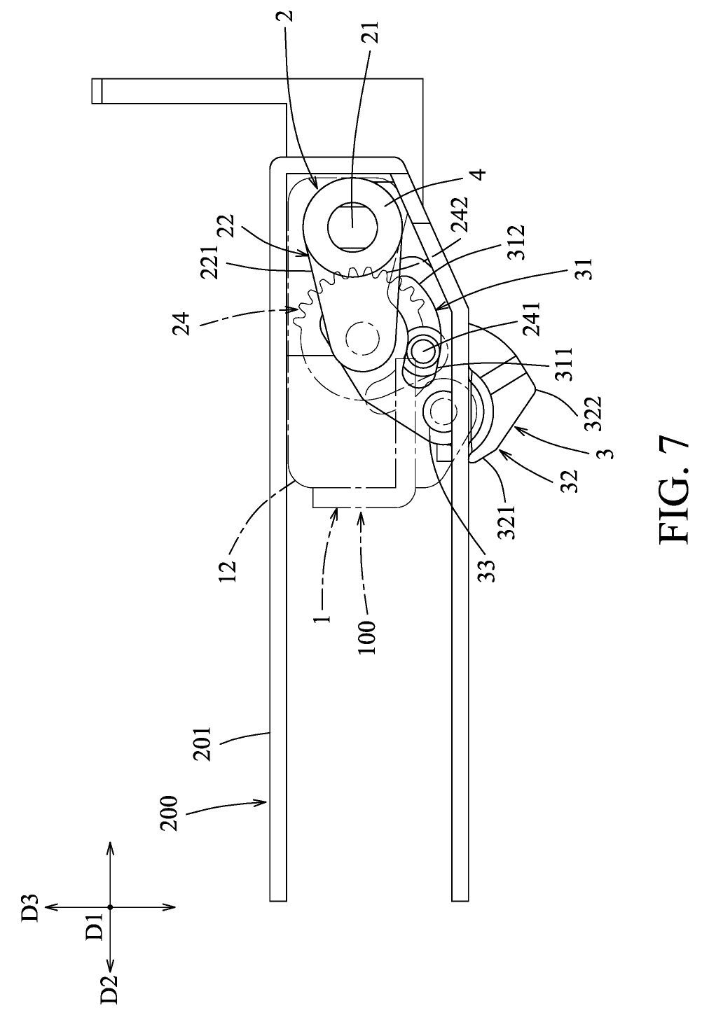

Referring to FIG. 7, when the rotating member 21 continues to rotate to the transition position, the second housing is open relative to the first housing 201 by approximately 90 degrees. At this time, the connecting protrusion 241 returns to the intersection of the driving portion 311 and the arcuate portion 312 from the distal end of the driving portion 311, and the rotating foot cushion member 3 is driven to rotate to the supporting position by the connecting protrusion 241. In this state, the foot cushion body 32 of the rotating foot cushion member 3 is relatively far from the base seat 1, and the second foot cushion portion 322 is lower than the first foot cushion portion 321 in position. It is worth noting that the second foot cushion portion 322 (a portion adapted for support) of the foot cushion body 32 of the rotating foot cushion member 3 is roughly located below the pivot connecting portion 33 of the rotating foot cushion member 3, so that a reaction force received by the foot cushion body 32 is not easily converted into a torque that causes the rotating foot cushion member 3 to rotate relative to the base seat 1, thereby preventing the rotating foot cushion member 3 from returning to the folded position.

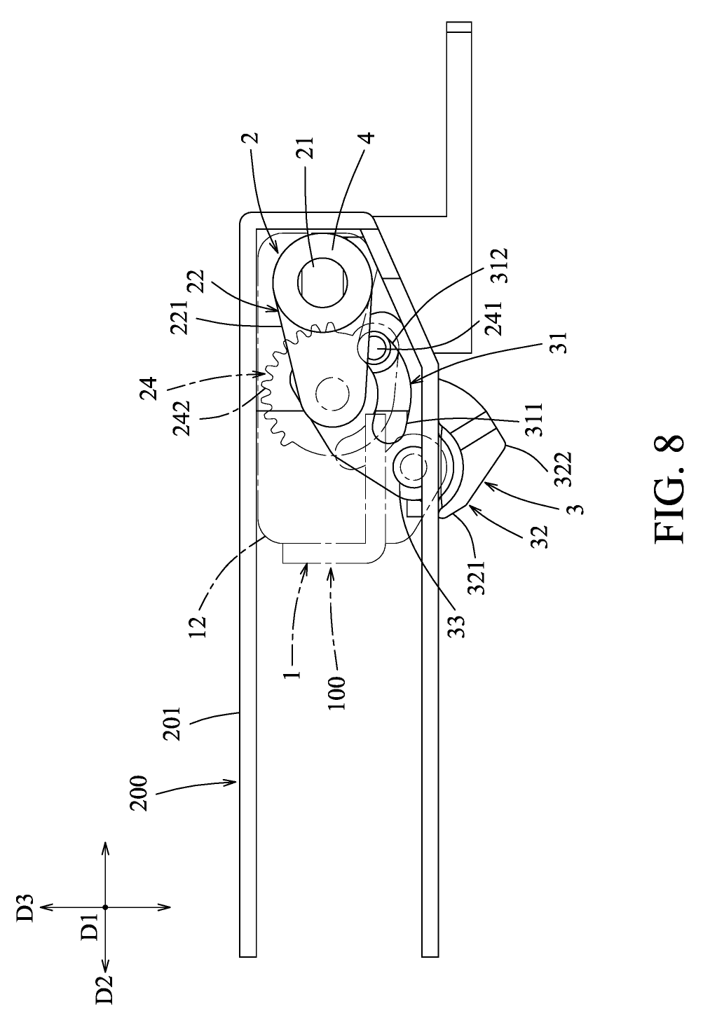

Referring to FIG. 8, when the rotating member 21 rotates from the transition position to the second position, the second housing is open relative to the first housing 201 by approximately 180 degrees, the connecting protrusion 241 slides along the arcuate portion 312 to an end of the arcuate portion 312 distal from the driving portion 311, and the rotating foot cushion member 3 does not rotate. It should be noted that since a distance between the connecting protrusion 241 of the cam member 24 and the second rotational axis (A2) is fixed and equal to the radius of curvature of the arcuate portion 312, when the connecting protrusion 241 is in the arcuate portion 312, the rotating foot cushion member 3 is restricted in the supporting position and does not rotate, thereby preventing the rotating foot cushion member 3 from returning to the folded position.

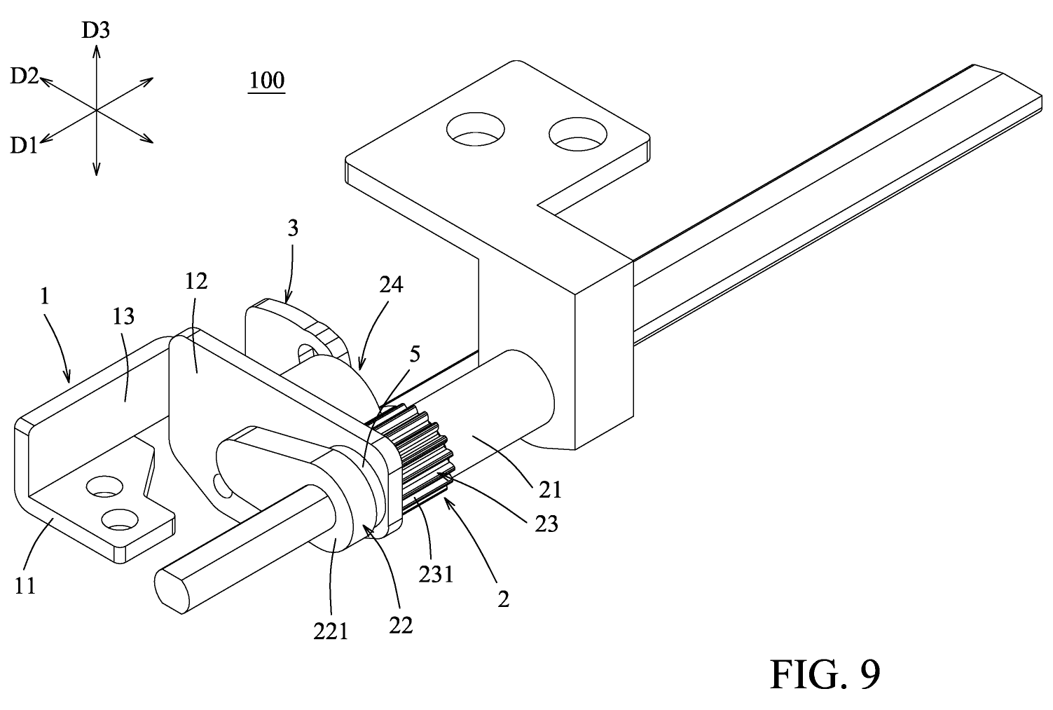

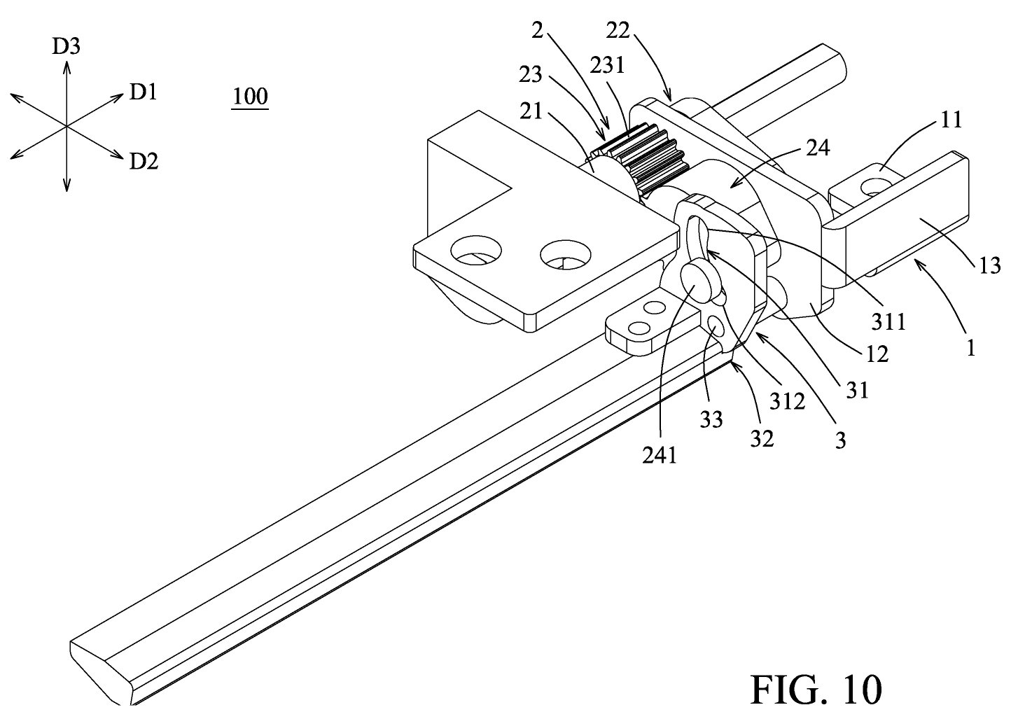

Referring to FIGS. 9 and 10, in an alternative embodiment of the hinge device 100 according to the present disclosure, the driving gear 23, the cam member 24, and the rotating foot cushion member 3 are located on the same side of the assembly plate body 12 of the base seat 1 in the left-right direction (D1). In addition, in this embodiment, a torque friction plate 5 may be disposed on the rotating member 21. The torque friction plate 5 synchronously rotates with the rotating member 21, is located between the fixing plate body 221 of the cam fixing member 22 and the assembly plate body 12 of the base seat 1, and is adapted for generating a frictional force with the cam fixing member 22 and the base seat 1 to resist the rotation of the rotating member 21, thereby allowing the electronic device 200 to be positioned at various angles and improving the user's tactile experience when opening and closing the electronic device 200.

In summary, by virtue of the connecting protrusion 241 cooperating with the cushion groove 31, the rotating foot cushion member 3 of the hinge device 100 may move with the rotating member 21. When the rotating member 21 rotates from the first position to the second position, the rotating foot cushion member 3 may be driven to rotate downwardly from the folded position to the supporting position. Therefore, when the hinge device 100 is used on the electronic device 200 such as a notebook computer, the rotating foot cushion member 3 may be conveniently used to lift a back side of the notebook computer. Moreover, by virtue of the driving portion 311 and the arcuate portion 312 of the cushion groove 31, when the connecting protrusion 241 is in the arcuate portion 312, the rotating foot cushion member 3 is restricted in the supporting position and does not rotate, thereby preventing the rotating foot cushion member 3 from returning to the folded position.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A hinge device, comprising:
a base seat;
a rotating unit including a rotating member and a connecting protrusion, said rotating member being mounted on said base seat and being capable of rotating relative to said base seat about a first rotational axis parallel to a lateral direction between a first position and a second position, said connecting protrusion being driven by said rotating member and being capable of rotating relative to said base seat about a second rotational axis parallel to said lateral direction; and
a rotating foot cushion member pivotably mounted on said base seat and being capable of rotating relative to said base seat about a third rotational axis parallel to said lateral direction between a folded position and a supporting position, said rotating foot cushion member having a cushion groove recessed in said lateral direction at one end of said rotating foot cushion member, a foot cushion body at another end of said rotating foot cushion member, and a pivot connecting portion pivotably connected to said base seat between said cushion groove and said foot cushion body, said connecting protrusion of said rotating unit being slidably disposed in said cushion groove;
wherein, when said rotating member is in the first position, said rotating foot cushion member is in the folded position, and said foot cushion body of said rotating foot cushion member is relatively close to said base seat;
wherein, when said rotating member rotates to the second position, said rotating foot cushion member is driven to rotate to the supporting position by said connecting protrusion, and said foot cushion body of said rotating foot cushion member is relatively far from said base seat.

2. The hinge device as claimed in claim 1, wherein said rotating member moves to a transition position during rotation from the first position to the second position relative to said base seat, said cushion groove having a driving portion and an arcuate portion connected to said driving portion, said connecting protrusion being located at an intersection of said driving portion and said arcuate portion and said rotating foot cushion member being in the folded position when said rotating member is in the first position,
said connecting protrusion sliding towards a distal end of said driving portion and then returning to said intersection of said driving portion and said arcuate portion when said rotating member rotates from the first position to the transition position, thereby driving said rotating foot cushion member to rotate to the supporting position, said connecting protrusion sliding along said arcuate portion and said rotating foot cushion member being not moved when said rotating member rotates from the transition position to the second position.

3. The hinge device as claimed in claim 2, wherein said driving portion is straight and is tangent to said arcuate portion.

4. The hinge device as claimed in claim 1, wherein said rotating unit further includes a cam member, said cam member being driven by said rotating member and being capable of rotating relative to said base seat about said second rotational axis, said cam member having said connecting protrusion protruding from one side of said cam member.

5. The hinge device as claimed in claim 4, wherein said rotating unit further includes a driving gear mounted on said rotating member and synchronously rotating with said rotating member, said driving gear meshing with said cam member.

6. The hinge device as claimed in claim 1, wherein said foot cushion body of said rotating foot cushion member has a first foot cushion portion relatively close to said pivot connecting portion and a second foot cushion portion relatively far from said pivot connecting portion, when said rotating foot cushion member is in the folded position, said first foot cushion portion being lower than said second foot cushion portion in position, when said rotating foot cushion member is in the supporting position, said second foot cushion portion being lower than said first foot cushion portion in position.
